(19) United States
(12) Patent Application Publication
(10) Pub. No.: US 2005/0258279 A1
(43) Pub. Date: Nov. 24, 2005

(54) Pressure compensating drip tape and related method

(75) Inventor: Charles R. Harrold, Walla Walla, WA (US)

Correspondence Address: NIXON & VANDERHYE, PC, 901 NORTH GLEBE ROAD, 11TH FLOOR, ARLINGTON, VA, 22203, US

(73) Assignee: Nelson Irrigation Corporation, Walla Walla, WA (US)

(21) Appl. No.: 10/851,225

(22) Filed: May 24, 2004

(51) Int. Cl. B05B 15/00

(52) U.S. Cl. 239/542; 239/547; 156/203

(57) ABSTRACT

A method for applying a first elongated strip of material over a second elongated strip of material wherein the second strip of material includes a pair of marginal edges on opposite sides of a secondary flow path for an irrigation drip tape, includes (a) applying heat to the second strip along the marginal edges while simultaneously shielding at least a center portion of the secondary flow path from the heat; and (b) pressing the first elongated strip over the second elongated strip to thereby heat seal the second elongated strip to the first elongated strip along the marginal edges. A related drip tape product includes a flexible tubular member having an interior defining a primary flow path, and a flow path strip bonded to an interior surface of the tubular member formed with a plurality of secondary flow paths. The flow paths have open sides facing the interior of the tubular member, and a thin, flexible membrane is bonded along marginal edges thereof to the flow path strip to close the open sides of the secondary flow paths.

This invention relates to irrigation drip tape used primarily in agricultural applications and, specifically, to a method and apparatus for forming drip tape incorporating a pressure compensation feature.

### BACKGROUND OF THE INVENTION

Drip irrigation hose or tape has been available now for several years, and is used above and/or below ground to deliver correct amounts of water to plants at root level. Typically, agricultural drip tape is formed from a relatively thin, flexible, continuous plastic strip or web folded over and seamed along a longitudinal edge to establish a primary flow path. One or more secondary flow paths are typically located adjacent the primary flow path by fixing discrete emitter devices along the length of the tape or hose, or by applying parallel strips of plastic material within the hose interior (for example, in the area of the longitudinal edge overlap) to form a secondary flow path. The tape is formed with inlets allowing water to move from the primary flow path into the secondary flow path, and outlets allowing water to flow from the secondary flow paths to atmosphere. In other words, water under pressure flows from the primary path to the secondary flow path, and then out of the drip tape in a controlled fashion. The secondary flow path reduces the pressure of the water so that it exits the tape outlets at essentially zero pressure. Some tape or hose constructions also incorporate turbulence-inducing regions in the secondary flow path to prevent clogging and to reduce the sensitivity of the flow rate to pressure changes.

Drip irrigation hoses or tapes as described above are well represented in the patent literature, and examples may be found in U.S. Pat Nos. 3,870,236; 3,896,999; 4,009,832; 4,247,051; 4,430,020; 4,473,191; 4,874,132; 4,880,167; 4,984,739; 5,163,622; 5,181,532; 5,203,503; 5,207,386; 5,282,578; and 5,333,793. The incorporation of pressure compensation has also been attempted with varying degrees of success. Examples may be found in U.S. Pat. Nos. 3,993,248; 4,009,832 and 5,111,995. Relatively rigid discrete emitters have also been employed to provide a pressure compensation feature. See, for example, U.S. Pat. Nos. 4,210,287; 5,330,107; 5,609,303 and 5,813,603.

In commonly owned U.S. Pat. No. 5,688,072, a drip tape construction is disclosed wherein the tape is formed by a strip or web of flexible polyethylene (PE) material folded over and seamed along overlapped longitudinal edges. Interiorly of the tape, and in an area remote from the overlapped seam, there is a longitudinally extending plastic bead or strip which incorporates a series of axially spaced secondary flow paths. Each secondary flow path has inlet, turbulence-inducing, and outlet regions, all of which are pre-formed on one side of a hot melt bead or strip. The pattern or flow path side of the bead is applied face down on the strip so that the strip wall itself closes the secondary flow path except for a plurality of inlets formed in the bead at longitudinally spaced locations along the inlet region. These inlets are arranged perpendicular to the longitudinal axis of the tape, and thus also perpendicular to the direction of flow in the secondary flow path. The inlets are located on both sides of the secondary flow path, in longitudinally spaced relationship.

The inlet region of each secondary flow path leads to a turbulence-inducing region formed by a series of inwardly directed projections on opposite sides of the secondary flow channel, in longitudinally offset relationship. This arrangement creates a tortuous path which induces turbulence in the water flowing along the secondary flow path, before exiting the tape.

The outlet region, or reservoir, is otherwise axially closed in the downstream direction, thus isolating the path from the inlet region of the next adjacent downstream secondary flow path, and thus also forcing all water to exit via the elongated slit in the tape wall. This drip tape configuration does not, however, include any pressure compensation feature.

In commonly owned U.S. Pat. No. 6,382,530, there is disclosed a unique pressure compensation-type drip tape that includes a flexible tape or tubular member defining a primary flow path and a longitudinally extending pre-formed bead or strip incorporating multiple, axially oriented secondary flow paths. Each secondary flow path is formed in the strip or bead on three sides with the remaining open face sealed against the tape wall that forms the fourth side of the secondary flow path. Alternatively, it is disclosed that the secondary flow path can face the interior of the tape and be sealed by a second or cap strip with a flexible membrane loosely located therebetween.

In either case, the secondary flow path is formed with inlet, turbulence-inducing, pressure compensation and outlet regions as described in the '550 patent. The pressure compensation region is located axially between the turbulence-inducing region and the outlet region. It includes a pair of laterally spaced, ramped surfaces, preformed in the bead or strip, extending in the longitudinal or flow direction. More specifically, in the embodiment where the open-faced bead is closed by the tape wall, the ramped surfaces taper from the secondary flow path toward the tape wall in the direction of flow. In the alternative embodiment, where the secondary flow path faces the interior of the tape and is closed by a cap strip, the ramped surfaces taper toward the cap strip in the flow direction. As pressure in the primary flow path rises, the ramped area will be forced to move toward the tape wall (in the alternative embodiment, the radially inner cap strip moves toward the ramped area), thus restricting flow. The outlet region in both embodiments includes a longitudinal chamber with a plurality of axially spaced transverse ribs or other protrusions preventing unwanted shut-off of flow to the outlet. The outlet chamber has a single-slit outlet, but there may be circumstances where two or more axially aligned outlet slits are provided for each secondary flow path. Method and apparatus for forming drip tape of this type is disclosed in commonly-owned U.S. Pat. No. 6,120,634.

### BRIEF DESCRIPTION OF THE INVENTION

This invention relates to the manufacture of drip tape having a construction similar to that described above and in the '350 patent where the secondary flow path strip is adhered to the interior surface of the drip tape with the open path facing the interior of the tape. In this invention, the secondary flow path is covered with a flexible cap strip or membrane of elastomeric material bonded to the marginal edges of the flow path strip. The invention is particularly concerned with the manner in which the flexible membrane, or cap strip, is secured over the exposed secondary flow path.

Briefly, the process starts with the secondary flow path strip being deposited or bonded, in an inverted or upside down position, on a continuously moving PE sheet or web while moving through a typical path station as described in the '634 patent. The joined web and flow path strip continues to a second station and moves under a heating unit which heats the edges of the secondary flow path strip sufficiently to cause the edges to reach a semi-molten state. The heat comes from an energy source such as hot air, infrared, or lasers. At the same time, there is a shield or deflector located in the center of the heat source which blocks, diverts or deflects the heat away from at least a center portion of the secondary flow path, and preferably the center 50 to 75% of the secondary flow path. This is done to assure that, as the web and flow path strip move to the next station where a flexible membrane or cap strip is bonded to the outer or marginal edges of the path, the membrane or cap strip will not stick to the still cool central area of the secondary flow path.

As the heated flow path strip moves under a transfer wheel, a continuous strip (also referred to as the cap strip) of flexible membrane or diaphragm material, such as silicone, is bonded to the flow path strip, creating a closed or capped passage.

It is also possible, however, to use a somewhat stiffer strip of PE for the cap strip, and then create openings in the cap strip relative to the tortuous path area. These openings may then be covered by strips of membrane material to create the desired degree of flexion for pressure compensation. This arrangement may be more economical and also would eliminate the possibility of the membrane or cap strip deflecting in other areas such as the outlet basin which would cause loss of flow through the outlet slit or slits. With these arrangements, it has been discovered that adequate pressure compensation is achieved through the interaction of the membrane and the turbulence-inducing region of the secondary flow path, allowing the pressure compensation ramps to be eliminated.

Finally, a new outlet design is disclosed that achieves a more reliable and uniform dispensation of water from the tape. More specifically, an outlet aperture hole or slit is formed in a hollow, generally cylindrical projection, pushed upwardly out of the main or primary flow path. When water drips out of the hole or slit, it will separate more easily from the tape and not tend to simply run along the tape.

Thus, in one aspect, the invention relates to a method for applying a first elongated strip of material over a second elongated strip of material wherein the second strip of material includes a pair of marginal edges on opposite sides of a secondary flow path for an irrigation drip tape, the method comprising: (a) applying heat to the second strip along the marginal edges while simultaneously shielding at least a center portion of the secondary flow path from the heat; and (b) pressing the first elongated strip over the second elongated strip to thereby heat seal the second elongated strip to the first elongated strip along the marginal edges.

In another aspect, the invention relates to a method of forming irrigation drip tape comprising: (a) passing an elongated web, adapted to form a primary flow path, through a first heating station where heat is applied along a narrow band of the web in a direction of travel of the web; (b) applying a pre-formed bead of material to the narrow band, the pre-formed bead having a secondary flow path formed therein facing away from the narrow band; (c) heating marginal edges of the pre-formed bead while simultaneously shielding at least a center portion of the secondary flow path to prevent heating of said center portion of the secondary flow path; (d) applying a cap strap over the secondary flow path and heat sealing the cap strip along the heated marginal edges of the pre-formed bead.

In still another aspect, the invention relates to irrigation drip tape comprising a flexible tubular member having an interior defining a primary flow path; a flow path strip bonded to an interior surface of the tubular member formed with a plurality of secondary flow paths, the secondary flow paths in substantially axially aligned relationship along a length dimension of the tubular member, the flow paths having open sides facing the interior of the tubular member; each of the secondary flow paths comprising, in axial sequence, at least an inlet region, a turbulence-inducing region and an outlet region including at least one outlet in the outlet region for emitting water from the secondary flow path to atmosphere; and a thin, flexible membrane bonded along marginal edges thereof to the flow path strip to close the open sides of the secondary flow paths and to provide pressure compensation within the secondary flow paths.

The invention will now be described in detail in connection with the drawings identified below.

### BRIEF DESCRIPTION OF THE DRAWINGS

FIG. 1 is a partial perspective view of a drip tape construction in accordance with one exemplary embodiment of the invention;

FIG. 2 is a partial perspective of the drip tape construction in FIG. 1, but illustrating a partially completed secondary flow path adhered to the interior surface of the tape;

FIG. 3 is a simplified perspective view of apparatus used to form the drip tape shown in FIGS. 1 and 2;

FIG. 4 is an enlarged detail taken from FIG. 3; and

FIG. 5 is a cross section through a new outlet configuration in accordance with the invention.

### DETAILED DESCRIPTION OF THE INVENTION

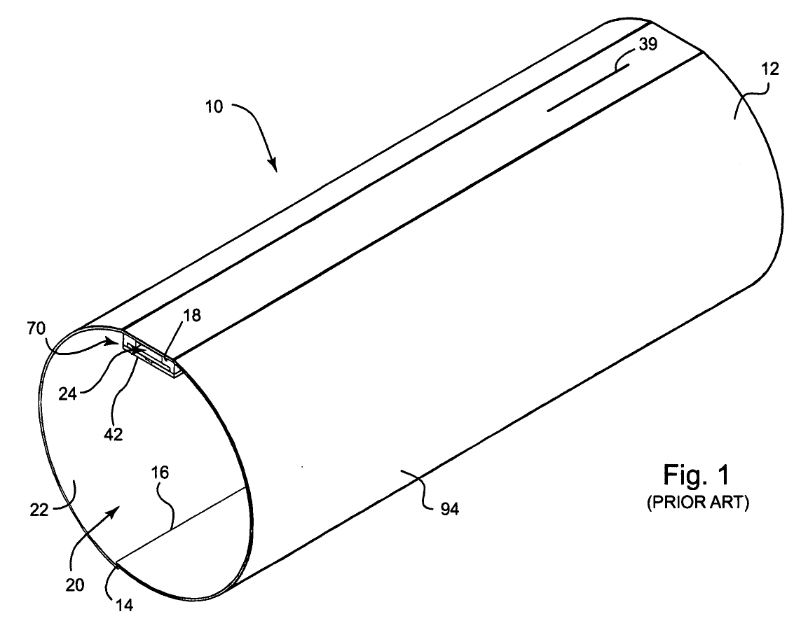

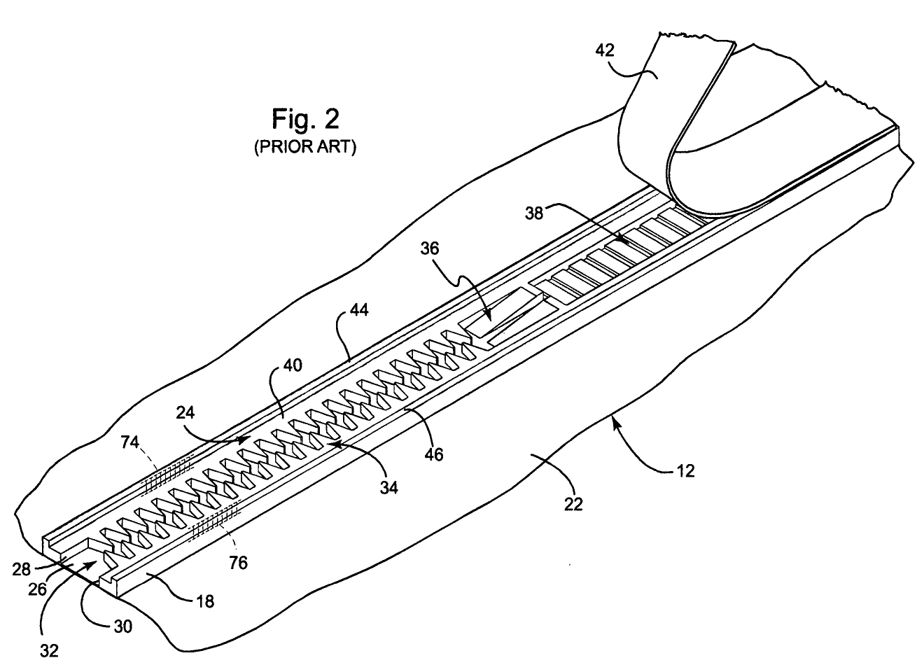

Referring to FIGS. 1 and 2, the drip tape or tube 10 in accordance with one exemplary embodiment of the invention includes a flexible plastic film or web 12 (sometimes also referred to as the “tape wall”) with opposite longitudinal edges 14 and 16 overlapped and bonded to form a tubular member with a single longitudinal seam. The tube or tape 10 could also be formed by extrusion, in which case, no overlapped seam would be present. This tube or tubular member is designed (with suitable couplings) for attachment at one end to a source of water under pressure and thus provides a primary flow path for water to be delivered to the desired site.

As best seen in FIG. 2, a PE strip 18 is pre-formed to define a plurality of axially aligned secondary flow paths described further below. The secondary flow paths are identical, and only one such path need be described in detail. In the exemplary embodiment, the flow path strip 18 is adhered to the interior surface 22 of the web 12 with the secondary flow path 24 formed in the strip 18 facing the interior of the tape, i.e., open to the primary flow path 20 (FIG. 1). The secondary flow path strip 18 including the secondary flow path 24 extends along and parallel to the longitudinal axis of the tape.

In the exemplary embodiment, the secondary flow path 24 is defined by three sides including a bottom 26 and a pair of side walls 28, 30 with the “open” fourth side of the flow path 24 subsequently “closed” by a thin flexible cap strip or membrane 42. One particularly suitable material for the cap strip or membrane 42 is commercially available under the name Santoprene Thermoplastic Elastomer (or TPE). This is a rubber-like material that, unlike conventional vulcanized rubbers, can be processed and recycled like a thermoplastic material and that provides the desired flexion for pressure compensation.

The pre-formed secondary flow paths 24 are located in discrete longitudinal intervals, e.g., about every 12″ along the length of the bead or strip. It will be appreciated, however, that the secondary flow paths may be spaced at other intervals, e.g., 4″, 8″, 12″, 24″, 36″, etc. as desired. The secondary flow paths are isolated from each other within the strip so that no flow is permitted from one secondary flow path to another. Each flow path 24 has four distinct regions—an inlet region 32, a turbulence-inducing region 34, a pressure compensation region 36, and an outlet region 38 in axial alignment. The flow path 24 preferably has a depth of about 0.030″. The outlet region 38 communicates with an elongated slit 39 (FIG. 1) in the tape wall which allows the water in the secondary flow path to escape in a controlled drip-like fashion. Additional details concerning the construction of the flow path 24 may be found in the above-identified '530 patent.

As mentioned above, the secondary flow path strip 18 is preferably formed of PE and is secured to the web 12 in inverted fashion, i.e., with the open sides of the secondary flow paths 24 facing inwardly, i.e., towards the center of the tape. The side walls 28, 30 extend from the bottom 26, beyond the secondary flow path top surface 40, so as to permit bonding of the flexible membrane or cap strip 42 on the raised edges or shoulders 44, 46 created by extension of the side walls 28, 30 beyond surface 40.

Alternatively, the membrane or cap strip 42 may be sized to fit within (between) the shoulders 44, 46 of the flow path 24 so as to directly engage the surface 40. In this case, the cap strip 42 is bonded only to the marginal edges of surface 40, i.e., the surface portions on either side of the flow path per se, as further described below.

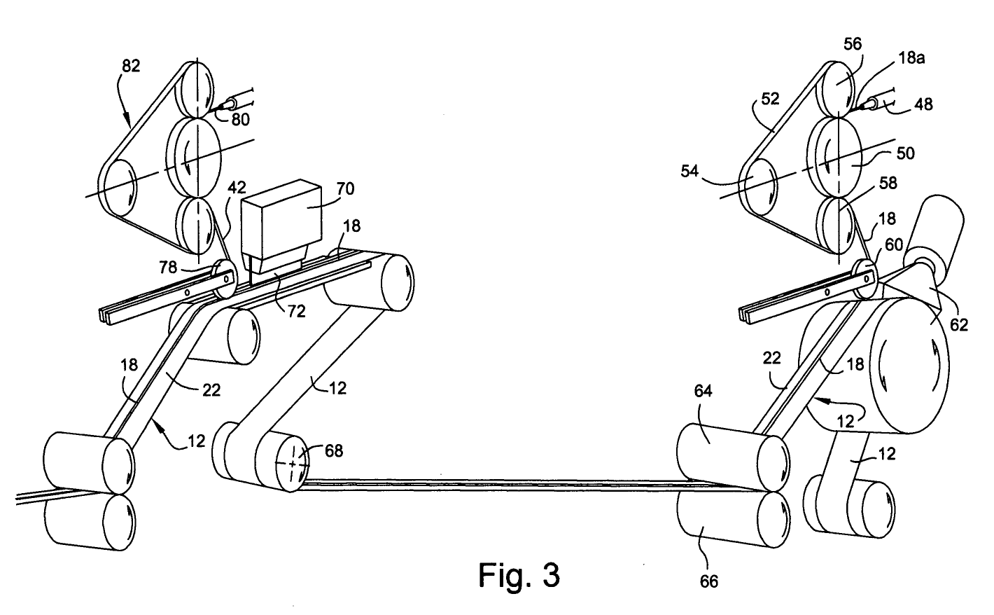

FIG. 3 shows in simplified form apparatus for attaching the secondary flow path strip 18 and 24 (FIG. 2) to the surface 22 of web 12 and for attaching the membrane or cap strip 42 to the open side of the secondary flow path 24.

Initially, flow path strip material 18a is extruded from an extruder 48 onto a rotating form wheel 50 which has the secondary flow path geometry etched or engraved on its periphery in the form of a continuous groove. The secondary flow path geometry per se may be axially repeated at predetermined intervals of, e.g., twelve inches within the continuous groove, separated by, e.g., an integrally formed solid barrier. Thus, depending on the size of the form wheel 50 and the length of each flow path, one or more such flow paths may be etched in the form wheel.

The form wheel 50 is engaged with a continuous belt 52 which compresses the material 18a into the groove geometry on the periphery of the wheel 50. The belt 52, preferably made of stainless steel, contains and supports the extruded bead 18a through a portion (about 270°) of the wheel. The belt 52 thus follows a path of about 180° around roll 54, and then around roll 56, with a direction change so that it enters the nip between roll 56 and form wheel 50. The belt 52 travels substantially 270° about the form wheel 50, around roll 58 and back to roll 54. Meanwhile, the extrudate 18a enters the nip between roll 56 and form wheel 50 so that it is sandwiched between the belt 52 and the wheel 50. The material 18a then follows the belt about the roll 58 (now outside the belt 52) before diverging from the belt to enter a new station where the now fully-formed flow path strip 18, including flow paths 24 is bonded onto the interior surface 22 of web 12 (in an inverted orientation) such that the flow paths 24 per se face inwardly, i.e., into what will become the primary flow path 20.

The web 12 receives the pre-formed and cooled flow path strip 18 from transfer roll 60. Upstream of the transfer roll 60, the web 12 is heated along a predetermined line offset from the centerline by a narrow band of heated air (about 1100° F.) from a heater 62 having a narrow arcuate nozzle (not shown). The pre-formed flow path strip 18 is then applied to the narrow heated band of the web 12 in continuous fashion. The web 12 and strip 18 then enter the nip between rolls 64, 66. Light pressure (about 5 to 9 lbs.) applied by these rolls aids in the bonding process as the flow path strip is pressed onto the heated web.

The web 12 (with the pre-formed flow path strip 18 bonded thereto) moves from rolls 64, 66 and passes about an adjustable tension roll 68 and then to another heating station where heat is applied by a second heater 70.

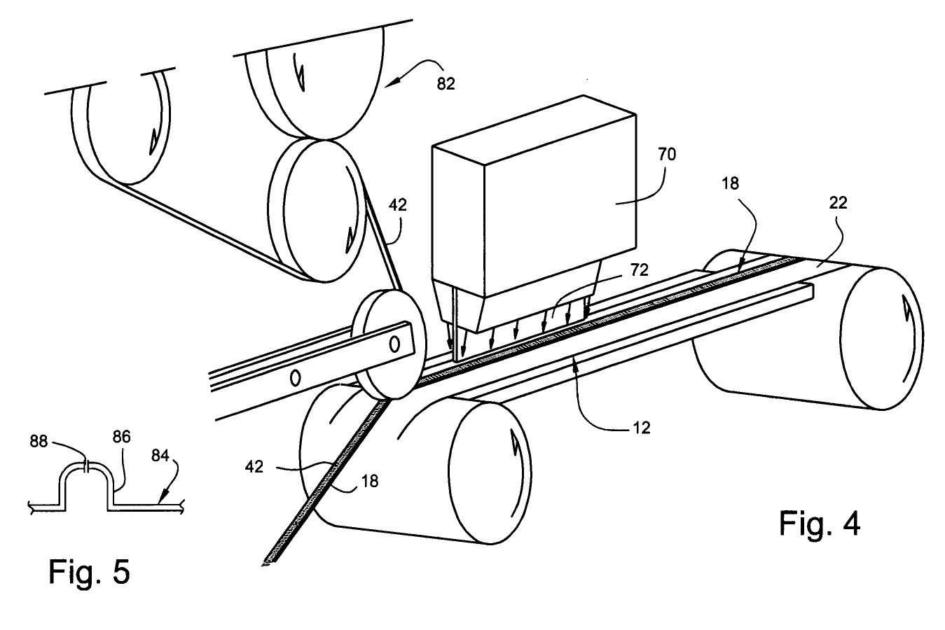

The heater 70 may be an energy source such as hot air, infrared, or lasers. As best seen in FIG. 4, an elongated plate-like shield 72 projects downwardly from the center of the heater, aligned with the center area of the pre-formed flow path strip 18 in the direction of movement of the joined web and strip. The shield 72 blocks, diverts or deflects heat away from at least a center portion, and preferably the center 50 to 75% of the exposed secondary flow path 24, so that only the marginal edges 74, 76 (see FIG. 2) of the flow path are heated. As the edge-heated flow path 24 moves under the transfer roll 78 (FIG. 3), a continuous strip of extruded flexible material, serving as the flow path cap strip or membrane 42, is applied over the open face of the bead so as to cover the flow path, but the cap strip 42 is bonded only along the heated marginal edges 74, 76 (FIG. 2). The cap strip 42 is preferably extruded to a thickness of from 0.005 to 0.025 in. and preferably about 0.020 in. and formed to a smooth rectangular cross section by a roll forming wheel and belt assembly 82 similar to forming wheel 50 and associated belt 52 (FIG. 3). The web 12 with strip 18 and cap strip 42 applied thereto, moves on to a folding, heat sealing station to complete the formation of the drip tape. The additional apparatus, not shown here, is disclosed in the '634 patent.

In an alternative arrangement, the cap strip 42 may be made of a stiffer material such as PE, with openings formed at the appropriate axial locations along the strip where pressure compensation is desired. After the cap strip is applied to the web as described above, more flexible silicone membrane material may be applied in strip form over the openings to thus provide the desired flexion only at the desired areas.

One additional benefit to the above arrangements has been the discovery that the side-by-side ramps in the pressure compensation region 36 described above (and shown in FIG. 2) can be eliminated. This is because adequate pressure compensation is achieved in the turbulence-inducing area with the utilization of the thin membrane or cap strip.

With reference now to FIG. 5, a new secondary flow path outlet configuration is illustrated. Specifically, the outer wall of the tape 84 is deformed outwardly in the outlet region of the secondary flow path to create a hollow, generally cylindrical upwardly directed projection 86. The tip of the projection is formed with a pin hole or slit 88 for dispensing water to atmosphere from the secondary flow path. It has been found that the water emitted from the tape more easily separates from the tape, leading to more accurate and reliable placement of the water.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method for applying a first elongated strip of material over a second elongated strip of material wherein the second strip of material includes a pair of marginal edges on opposite sides of a secondary flow path for an irrigation drip tape, the method comprising:
(a) applying heat to said second strip along said marginal edges while simultaneously shielding at least a center portion of said secondary flow path from the heat; and
(b) pressing said first elongated strip over said second elongated strip to thereby heat seal said second elongated strip to said first elongated strip along said marginal edges.

2. The method of claim 1 wherein said first elongated strip comprises a flexible silicone material.

3. The method of claim 1 wherein said second elongated strip comprises polyethylene.

4. The method of claim 1 wherein, prior to step (a), said second elongated strip is heat-sealed onto a drip tape web with said marginal edges and secondary flow path facing away from said web.

5. The method of claim 1 wherein step (a) is carried out with hot air.

6. The method of claim 1 wherein step (a) is carried out with infrared heat.

7. The method of claim 1 wherein step (a) is carried out with a laser.

8. The method of claim 1 wherein, during step (b), 50 to 75% of said secondary flow path is shielded from heat.

9. The method of claim 1 wherein steps (a), (b) and (c) are carried out while said first and second elongated strips are moving continuously along a process path.

10. A method of forming irrigation drip tape comprising:
(a) passing an elongated web, adapted to form a primary flow path, through a first heating station where heat is applied along a narrow band of said web in a direction of travel of said web;
(b) applying a pre-formed bead of material to said narrow band, said pre-formed bead having a secondary flow path formed therein facing away from said narrow band;
(c) heating marginal edges of said pre-formed bead while simultaneously shielding at least a center portion of said secondary flow path to prevent heating of said center portion of said secondary flow path;
(d) applying a cap strap over said secondary flow path and heat sealing said cap strip along said heated marginal edges of said pre-formed bead.

11. The method of claim 10 wherein said first elongated strip comprises a flexible silicone material.

12. The method of claim 10 wherein said second elongated strip comprises polyethylene.

13. The method of claim 10 wherein step (c) is carried out with hot air.

14. The method of claim 10 wherein step (c) is carried out with infrared heat.

15. The method of claim 10 wherein step (c) is carried out with a laser.

16. The method of claim 1 wherein, during step (b), 50 to 75% of said secondary flow path is shielded from heat.

17. The method of claim 1 wherein steps (a), (b) and (c) are carried out while said first and second elongated strips are moving continuously along a process path.

18. Irrigation drip tape comprising:
a flexible tubular member having an interior defining a primary flow path;
a flow path strip bonded to an interior surface of said tubular member formed with a plurality of secondary flow paths, said secondary flow paths in substantially axially aligned relationship along a length dimension of said tubular member, said flow paths having open sides facing said interior of said tubular member; each of said secondary flow paths comprising, in axial sequence, at least an inlet region, a turbulence-inducing region and an outlet region including at least one outlet in said outlet region for emitting water from said secondary flow path to atmosphere; and a thin, flexible membrane bonded along marginal edges thereof to said flow path strip to close said open sides of said secondary flow paths and to provide pressure compensation within said secondary flow paths.

19. The irrigation drip tape of claim 18 wherein said turbulence-inducing region is connected directly to said outlet region.

20. The irrigation drip tape of claim 18 wherein a pressure compensation region is interposed between said turbulence-inducing region and said outlet region.

21. The irrigation drip tape of claim 18 wherein said thin flexible membrane comprises a thermoplastic elastomer.

22. The irrigation drip tape of claim 21 wherein said membrane has a thickness of about 0.005 to 0.025 in.
